(19) United States
(12) Patent Application Publication
(10) Pub. No.: US 2005/0194312 A1
(43) Pub. Date: Sep. 8, 2005

(54) Additive dispensing fluid filter

(75) Inventors: Stephan Niemeyer, Steinheim (DE); Thomas Wurster, Kaempfelbach (DE); Armin Jung, Bad Friedrichshall (DE); Guenther Schwarz, Rednitzhembach (DE)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 10/995,336

(22) Filed: Nov. 24, 2004

(30) Foreign Application Priority Data
Nov. 25, 2003 (DE) 10355403.3

(51) Int. Cl. B01D 11/00

(52) U.S. Cl. 210/634; 210/767; 210/209; 210/450; 210/443

(57) ABSTRACT

A filter for filtering a liquid, such as coolant for an internal combustion engine, having a filter housing with at least one liquid inlet and at least one liquid outlet, a filter element which is arranged in a sealing manner between the inlet and outlet so that the filter element separates a filtered liquid side from an unfiltered liquid side, and having an additive or inhibitor disposed in the housing such that when contacted by liquid passing through the filter, the additive is released into the liquid, in which the additive is tightly encased in a liquid-soluble material which dissolves on coming in contact with the liquid being filtered.

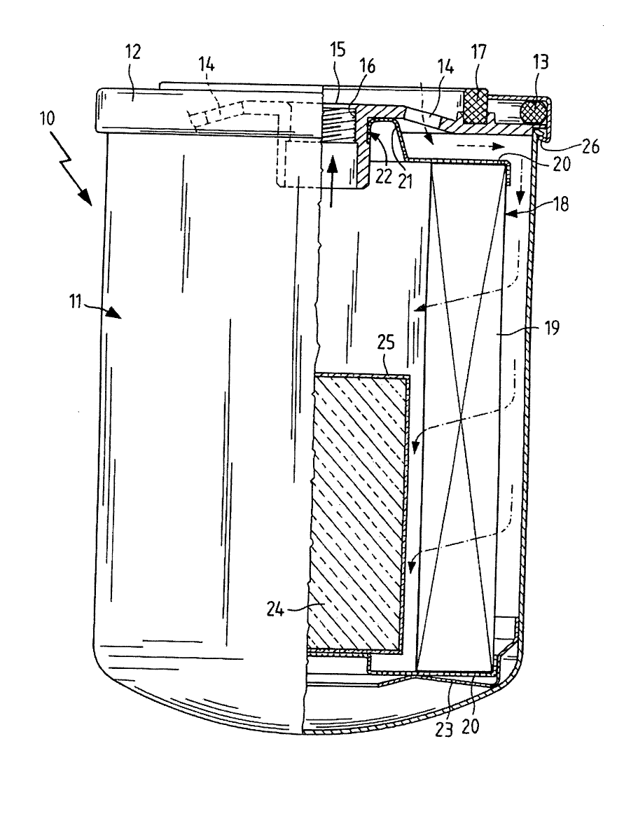

### CROSS REFERENCE TO RELATED APPLICATIONS

This application claims priority from Federal Republic of Germany patent application no. DE 103 55 403.3, filed Nov. 25, 2003, the entire disclosure of which is incorporated herein by reference.

### BACKGROUND OF THE INVENTION

The present invention relates to a liquid filter for filtering a liquid comprising a filter housing with a liquid inlet and a liquid outlet, a filter element arranged in a sealing manner between the inlet and outlet, and an active agent arranged in the housing for release into a liquid being filtered. The present invention additionally relates to a method for filtering a liquid with simultaneous addition of an active ingredient into the liquid being filtered.

Components of systems that carry liquids are very often exposed to attack by the aggressive components of the liquid or to corrosion due to the liquid being carried. For example, the metal components of water-cooled internal combustion engines are exposed to corrosion and also to damage due to freezing of the cooling water. To prevent this, coolant additives in liquid or solid form, which are supposed to prevent these problems, are added to the coolant. However, the effect of such additives declines over a period of time and depends on the conditions to which they are subjected.

Many liquid systems are designed, however, as mostly closed systems, with both liquid and the coolant, for example, being designed as a lifetime filling in a modern engine, to be replaced only in the event of damage. Therefore, inhibitors in solid or liquid form are added to the liquid in order to maintain the functionality of the liquid. These inhibitors are added after a certain period of time or at regular intervals. As used herein, the term “inhibitors” refers to substances that restrict or inhibit chemical or physiological processes. One possibility of introducing such inhibitors into liquids is to integrate the respective inhibitory chemicals into replaceable filters for the liquid system, where the inhibitors then dissolve within a defined period of time, so they come in contact with the liquid.

Published European patent application no. EP 815,916 describes a coolant filter which includes a device for slow release of additives. This publication discloses a replaceable coolant filter with an inlet and an outlet and an annular filter element arranged in it, with the supplemental coolant additive being arranged in the form of solid tablets in the hollow cylindrical interior space of the annular filter element and a device for gradual release of the additive being situated between the additive and the outlet. The disadvantage of this known liquid filter with integrated inhibitors is that increased safety measures are required for handling this filter until it is used (i.e., from the time the filters are manufactured until the filters are used by a mechanic). Inhibitors of this type usually have a toxic effect when they come in contact with skin or when inhaled, which is why gloves and a face mask must be worn when handling them. So that the filter can function as intended, it is necessary for the filter, after its manufacture has been completed, to have openings with direct access to the interior where the inhibitor is disposed. Consequently, dust or fragments of the toxic inhibitors may fall out when the filters are handled, which is why protective measures are required to be taken in handling the filters.

Another disadvantage of the known arrangement is that the inhibitor in such filters cannot be introduced in liquid or gelatinous form into the filter, because the liquid or gel could flow out when handling the filters.

### SUMMARY OF THE INVENTION

It is an object of the present invention to provide an improved liquid filter which can dispense an additive into a liquid being filtered.

Another object of the invention is to provide a liquid filter which can dispense an additive into a liquid being filtered and which does not require special safety precautions to be taken during handling.

It is also an object of the invention to provide a liquid filter which can dispense an additive into a liquid being filtered and which includes a barrier to prevent a person handling the filter prior to its installation from coming into contact with the additive.

A further object of the invention is to provide a liquid filter which can dispense a liquid or gelled additive into a liquid being filtered.

An additional object of the invention is to provide an improved method for filtering a liquid and introducing an additive into the liquid being filtered.

These and other objects are achieved in accordance with the present invention by providing a filter for filtering a liquid, the filter comprising a filter housing with at least one liquid inlet and at least one liquid outlet, and a filter element arranged in a sealing manner between the inlet and outlet so that the filter element separates a filtered liquid volume from an unfiltered liquid volume, wherein an additive is provided in the housing which when contacted by the liquid being filtered releases an active ingredient into the liquid, the additive being encased in a liquid-soluble material which dissolves upon coming in contact with the liquid being filtered to expose the additive to the liquid.

In accordance with a further aspect of the invention, the objects are also achieved by providing a method of introducing an additive into a liquid to be filtered, comprising encasing the additive in a material soluble in the liquid to be filtered, disposing the encased additive in a liquid filter, connecting the liquid filter to a liquid circuit in which the liquid to be filtered circulates so that the liquid to be filtered flows through the filter, and contacting the encased additive with the liquid to be filtered to dissolve the liquid-soluble material, so that the additive is exposed to the liquid and is released into the liquid.

Examples of additives which may be used in the invention include substances which are used to inhibit corrosion, or to prevent decomposition of the liquid, or to inhibit microbial growth.

The filter for filtering liquids according to the invention, in particular a coolant filter, comprises a filter housing with at least one liquid inlet and at least one liquid outlet and a filter element arranged in a sealing manner between the inlet and outlet. The filter element thus separates a filtered liquid side of the filter from an unfiltered liquid side. In addition, an additive (e.g., an inhibitor) is provided in the housing. The additive dissolves and/or decomposes upon coming into contact with the liquid, thereby releasing the active ingredient into the liquid. The inhibitor may exist in solid, liquid or gelatinous form. The housing is preferably substantially cylindrical in shape, but oval or angular housing shapes and designs are also conceivable without leading to any filtering restriction.

In order for the inhibitor not to come in contact with the environment during handling, in particular not to come in contact with the skin or respiratory tract of the person handling it, it is tightly sealed with a liquid-soluble material which dissolves on coming into contact with the liquid to be filtered. The dense coating covering the additive or inhibitor dissolves and/or decomposes, and the additive or inhibitor then also comes in contact with the liquid to be filtered. As soon as this takes place, the inhibitor also decomposes, releasing the active ingredients to the liquid. In this way, handling of the filter can be greatly simplified, so that the inhibitor cannot come in contact with the skin or lungs of a person handling the filter prior to installation, and far less stringent safety precautions need to be taken. This also yields a definite advantage in the manufacturing cost of such a filter because the encapsulation of the additive reduces the need for strict safety precautions which are associated with high manufacturing costs.

Likewise, the filter of the invention makes it possible to use liquid of gelatinous additives or inhibitors in the filter, which are also released only in the liquid circuit to be filtered because they are encapsulated or tightly enclosed in the liquid-soluble material.

In accordance with one advantageous embodiment of this invention, the filter element is an annular filter element pleated in a zigzag pattern, as has been repeatedly used and disclosed in the state of the art. The inhibitor is situated in the interior of the annular filter element. The medium preferably flows through the filter from the outside to the inside, so the inhibitor is on the filtered liquid or “clean” side of the filter. However, it is also possible for the medium to flow through the filter from the inside to the outside. The direction of flow depends largely on the characteristics of the liquid system. Thus, the invention has the advantage that older types of filters—either openable filters in which the filter element can be changed or non-openable replaceable filters—can also be fitted with an inhibitor. No additional chambers or areas are necessary, so that invention can be implemented in existing types of filters without any additional re-design costs.

The liquid-soluble material encapsulating the additive may advantageously be a polyvinyl alcohol film, which dissolves upon coming in contact with water without leaving a residue. The polyvinyl alcohol film can be handled very easily, so that impervious encapsulation of the inhibitor can be accomplished easily by welding the film around the additive. When using liquid or gelatinous additives, it is possible through the choice of the chemical composition of the liquid-soluble material to weld a liquid into this material without having the material be destroyed from the inside due to the liquid welded into it.

The inhibitor is advantageously in a solid aggregate state when welded into the film, so that handling is very simple. The inhibitor may be in the form of a tablet or cube, but it is equally possible for the inhibitor to be in the form of a powdered solid when incorporated into the film.

As an alternative, as noted above, it is also possible to use the inhibitor in a liquid or gelled aggregate state. It is important only to be sure that the liquid-soluble material can be dissolved by the liquid to be filtered but is not attacked by the liquid or gelled additive.

In accordance with one embodiment of the invention, it is possible to adjust the point in time at which the release of the active inhibitor commences by varying the thickness of the liquid-soluble material. In many cases, it is essential for the inhibitor not to come in contact with the liquid to be filtered until after a certain predetermined time and only then release its active ingredients. It is then possible to create a certain time lag between liquid contact with the liquid-soluble material and liquid contact with the inhibitor on the basis of the material thickness of the liquid-soluble material. The greater the thickness of the liquid-soluble material layer, the longer the dissolving process will take. Thus, use of a thicker barrier coating will result in a longer dissolution time and a correspondingly longer delay until the additive is released into the liquid being filtered.

In accordance with an advantageous embodiment of this invention, the filter housing cannot be opened and the filter is designed as a replaceable or exchangeable filter. Since the filter should be changed after a certain interval anyway, the protection provided by the integrated inhibitor can also be replenished each time the filter is changed. Use of a filter housing which cannot be opened helps to prevent even unintentional contact with the inhibitor.

Alternatively, it is of course also possible to design the housing so that it can be opened and only the filter element is replaced. In this case the housing may either be integrated as a type of module into the liquid system or it may be connected via a flange to the liquid system. For example, it is possible to add the inhibitor only every second filter element change or to adjust the amount of inhibitor in the filter to the length of the intervals between changes. The encapsulated inhibitor may be introduced by hand into the filter element as a welded package. Alternatively, the encapsulated additive may be integrated into the interior of the filter element as a solid component.

This method of adding an active ingredient to a liquid in a filter as described above is broken down into the following steps: First the active ingredient in the form of an inhibitor is tightly enclosed in a liquid-soluble film, being sure that the liquid-soluble film can be dissolved only by the liquid that is to be filtered. As previously noted, the inhibitor here may be in the form of a solid, liquid or gel. In the second step, the encapsulated inhibitor is placed in the hollow cylindrical interior of the filter element, and the filter element then is inserted into the filter housing, after which the filter housing is sealed, although the inlet and outlet of the filter, of course, remain open. The advantage here is that the steps of assembling the filter do not entail the risk of contact with the inhibitor. In the next step, the filter is introduced into the liquid circulation system, in particular a coolant circulation system of an internal combustion engine, where the liquid flows through the inlet, through the annular filter element from the inside to the outside and on the way to the outlet fills up the interior of the hollow cylindrical filter with the inhibitor provided in it. Here again, the problem of someone coming in contact with the inhibitor during assembly of the filter does not exist. After the liquid-soluble film comes in contact with the liquid that is to be filtered, the film dissolves without leaving a residue so that no blockage of the filter or the outlet can occur, and the inhibitor then also comes in contact with the liquid flowing through the filter. Then the additive or inhibitor decomposes, releasing the active ingredients into the liquid.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWING

The invention will be described in further detail hereinafter with reference to illustrative preferred embodiments shown in the accompanying drawing figure which is a partially sectional front elevational view of a filter cartridge constructed in accordance with the present invention.

### DETAILED DESCRIPTION OF PREFERRED EMBODIMENTS

The figure shows a partially sectional schematic view of a filter cartridge according to the invention. The illustrated liquid filter 10 comprises a housing 11, which is sealed by a cover 12. A gasket 13 is provided in the area of contact between the cylindrical cover 12 and the cylindrical housing 11, with the cover 12 and the housing 11 being joined together by a crimped flanged edge 26. The cover 12 has a plurality of inlet openings 14, each preferably being designed to be circular and arranged in concentric rings.

It is optionally possible to equip all outlet openings 14 with a one-piece return-flow barrier composed, for example, of silicone rubber. A back-flow barrier of this type may be necessary in certain installation situations. An outlet opening 15 having an inside thread 16 is provided in the center of the cover 12. This liquid filter 10, which is a replaceable filter, is screwed onto the liquid system via the inside thread 16. In order to seal the connection between the liquid filter 10 and the liquid system (not shown here), a rectangular gasket 17 is provided in an axial circumferential groove in the cover 12 on the axial end of the cartridge to form an axial seal.

A filter element 18 comprising a filter medium 19 and two end disks 20 is provided in the interior of the housing 11. In the illustrated embodiment, the filter medium 19 is preferably made of a filter paper pleated in a star pattern. The end disks 20 are arranged on the end faces of the filter medium 19, with the end disk 20 facing the outlet 15 having a protruding collar 21, which carries a radial seal 22 to provide a tight separation between the inlet 14 and outlet 15. The radial gasket 22 is designed in one piece with the protruding collar 21 on the upper end disk 20. In order to fix the position of the filter element 18 axially, a spring element 23 is arranged in the lower area between the inside wall of the housing 11 and the underside of the lower end disk 20, which urges the filter element 18 against the cover 12.

An additive 24, such as a corrosion inhibitor, is provided as a annularly-shaped block in the interior of the filter element 18, which is in the form of a hollow cylinder. However, the additive may have any desired shape as long as it fits into the interior volume of the hollow cylindrical filter element 18. The additive 24 rests on the lower closed end disk 20. The inhibitor 24 is sheathed or completely encapsulated with an airtight seal by a liquid-soluble film 25 to prevent unintended release of the inhibitor to the surrounding air around the inhibitor. The inhibitor 24 is introduced into the interior volume of the hollow cylindrical filter element 19 prior to assembly of the filter element 18, after which in the next step the two end disks 20 are joined in a non-detachable manner to the filter medium 19.

As can be seen here, it is thus also possible to equip existing traditional types of replaceable filter cartridges with a liquid additive during an ongoing manufacturing process without having to observe any additional requirements regarding the safety of the employees processing these parts. When the filter cartridge is placed in service, and the liquid to be filtered is passed through it, the liquid contacts the encapsulated additive inside the filter element and gradually dissolves the protective film surrounding the actual additive. When the film is dissolved, the additive is released into the liquid circulating through the filter.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. A filter for filtering a liquid, said filter comprising a filter housing with at least one liquid inlet and at least one liquid outlet, and a filter element arranged in a sealing manner between the inlet and outlet so that the filter element separates a filtered liquid side from an unfiltered liquid side, wherein an additive is provided in the housing which when contacted by the liquid being filtered releases an active ingredient into the liquid, said additive being encased in a liquid-soluble material which dissolves upon coming in contact with the liquid being filtered to expose the additive to the liquid.

2. A filter according to claim 1, wherein the at least one filter inlet and at least one filter outlet are connected to a liquid coolant circuit of a liquid-cooled internal combustion engine.

3. A filter according to claim 1, wherein the filter element is an annular filter element, and the additive is disposed in the interior of the annular filter element.

4. A filter according to claim 3, wherein said annular filter element comprises is a star-folded filter paper.

5. A filter according to claim 1, wherein said liquid-soluble material is a polyvinyl alcohol film.

6. A filter according to claim 5, wherein said film is welded around the additive in a liquid-tight manner.

7. A filter according to claim 1, wherein said additive is in a solid aggregate state.

8. A filter according to claim 1, wherein said additive is in liquid form or in the form of a gel.

9. A filter according to claim 1, wherein the thickness of the liquid-soluble material is selected to release the additive after a predetermined period of time in contact with the liquid being filtered.

10. A filter according to claim 1, wherein said filter housing is permanently closed, and the filter is a replaceable filter cartridge.

11. A filter according to claim 1, wherein said filter housing is openable, and the filter element is a replaceable filter element, whereby a new supply of additive can be introduced with a replacement filter element.

12. A method of introducing an additive into a liquid to be filtered, said method comprising:
encasing the additive in a material soluble in the liquid to be filtered;
disposing the encased additive in a liquid filter;
connecting the liquid filter to a liquid circuit in which the liquid to be filtered circulates so that the liquid to be filtered flows through the filter; and
contacting the encased additive with the liquid to be filtered to dissolve the liquid-soluble material, whereby the additive is exposed to the liquid and is released into the liquid.

13. A method according to claim 12, wherein said additive is disposed inside an annular filter element of said filter.

14. A method according to claim 13, wherein said liquid filter is a replaceable filter cartridge comprising a permanently closed housing with said filter element therein.

15. A method according to claim 13, wherein said filter element is a replaceable filter insert adapted for insertion in an openable and reusable housing.

16. A method according to claim 12, wherein the liquid-soluble material is a polyvinyl alcohol film.

17. A method according to claim 16, wherein the encasing step is carried out by welding the film around the additive in a liquid-tight manner.

18. A method according to claim 12, further comprising selecting the thickness of the liquid-soluble material to release the additive after a predetermined period of time in contact with the liquid being filtered.

19. A method according to claim 12, wherein the connecting step is carried out by installing the filter in a cooling circuit of a liquid-cooled internal combustion engine.

20. A method according to claim 12, wherein the liquid-soluble material dissolves without leaving a residue.
